(19) United States
(12) Patent Application Publication
(10) Pub. No.: US 2022/0281028 A1
(43) Pub. Date: Sep. 8, 2022

(54) WELDING DEVICE AND METHOD FOR WELDING AT LEAST TWO COMPONENTS

(71) Applicant: SCHUNK SONOSYSTEMS GMBH, Wettenberg (DE)

(72) Inventors: Stefan TRUBE, Wettenberg (DE); Ivica GALIC, Rüber (DE)

(73) Assignee: SCHUNK SONOSYSTEMS GMBH, Wettenberg (DE)

(21) Appl. No.: 17/638,048

(22) PCT Filed: Sep. 9, 2019
(86) PCT No.: PCT/EP2019/073835

§ 371 Date: Feb. 24, 2022

(51) Int. Cl. B23K 20/10; B23K 26/346

(52) U.S. Cl. CPC B23K 20/10; B23K 26/346; B23K 2103/12

(57) ABSTRACT

A welding device and a method for welding at least two components. The welding device includes an ultrasonic welding device and a laser welding device and is configured to weld the two components together by ultrasonic welding in a first area with the aid of the ultrasonic welding device and, during the ultrasonic welding process, to weld the two components together by laser welding in a second area which is smaller than the first area and is arranged within and/or bordering an outer periphery of the first area, with the aid of the laser welding device. The ultrasonic welding device may have an ultrasonic sonotrode and/or an anvil which have a through opening within the first area, and the laser welding device may be configured to direct the laser beam through the through opening onto the second area on the two components.

### FIELD OF THE INVENTION

The present invention relates to a welding device and a method for welding at least two components.

### BACKGROUND OF THE INVENTION

For a wide variety of technical purposes, it may be necessary to connect two components firmly together. For example, in the context of a production of battery cells, typically a plurality of thin metallic films are to be connected to one another and/or to metallic sheets so as to have good electrical conduction and mechanical reliability.

In order to form a firm and mechanically highly loadable coupling between two components, they may be connected, for example, integrally bonded together. An integrally bonded connection may be generated, for example, by welding the two components together.

Different technologies are known that may be used to weld together components made of the same materials or of different materials. Each of these technologies may require particular boundary conditions and/or may bring particular advantages and disadvantages with it.

For example, it is known that components may be connected together by means of so-called friction welding. Therein, the components serving as joining partners are rubbed against one another at a boundary surface between the two components. Dependent upon boundary conditions such as a pressure exerted during the friction and/or an extent to which, or a speed at which, the two components are displaced relative to one another during the friction, an integrally bonded connection arises between the components.

So-called ultrasonic welding is known as a special manifestation of frictional welding. Therein, the components to be welded, also referred to as the welding goods, are brought as joining partners with their surfaces into abutment with one another and are moved against one another under slight pressure and with high frequency mechanical oscillations. The oscillations may herein be generated with the aid of a sonotrode in which ultrasonic oscillations are generated with frequencies of typically 20 kHz to 50 kHz and are transferred to at least one of the joining partners. Ultrasonic welding may be utilized both for welding metallic joining partners and also for welding joining partners of other materials, in particular, plastics. In the ultrasonic welding of metals, the oscillations are typically fed in to the joining partners horizontally, i.e. parallel to the surfaces to be welded together, so that they rub against one another. The connection arises, for example, after a shearing off of roughness peaks and/or a breaking off of an oxide layer substantially by means of an intermeshing and/or interlocking of the joining partners close to the surface. This takes place, in general, by means of plastic flow without the materials necessarily melting. This may be advantageous, in particular, for welding films, thin sheet metal and/or wires. Apart from punctiform welds, seam welds are also possible with rolling sonotrodes. Ultrasonic welding is also characterized by often very short weld times and high levels of efficiency. Different materials may be combined with each other. The components to be welded are typically heated slightly only in the weld region so that the surrounding material is mostly not damaged.

Laser welding, sometimes also called laser beam welding, is known as another welding technology. Laser welding is usually carried out, similarly to friction welding, without feeding in any additional material. A laser radiation emitted by a laser is focused by means of an optical system. A workpiece surface on an abutting edge, that is, a joining face of the components to be welded is situated in the direct vicinity of a focus of the optical system, i.e. in a focal spot. In most cases, the position of the focus relative to the component surface, i.e. above or below is an important welding parameter and also determines a weld penetration depth. The focal spot typically has a diameter of a few tenths of a millimetre and as a result, very high energy concentrations arise if the laser used has typical power output levels of a few kilowatts of laser power. Due to the absorption of the laser power, an extremely rapid rise in the temperature above a melting temperature of, for example, a metal used for the components takes place on the component surface so that a melt forms. Due to a high cooling speed, a weld seam created thereby becomes very hard, dependent upon the material and, in general, loses toughness.

Different combinations of the known welding method have been developed for different uses.

For example, it has been proposed to enhance locally, subsequently or previously, welds that have been created with a first welding method, for example, ultrasonic welding, by means of welds that are to be made with another welding method, for example, laser welding. In this way, advantages that may be achieved with each of these individual welding methods may be at least partially combined.

Furthermore, different modifications of known welding methods have been developed for different uses.

For example, in CN 107570872 A, a laser welding method assisted by ultrasonic vibrations is described. Similar methods are described in CN 108381039 A and CN 108326429 A.

### SUMMARY OF THE INVENTION AND OF ADVANTAGEOUS EMBODIMENTS

A need may exist for a welding device and a welding method for welding two components wherein properties of conventional welding technologies may be combined in an advantageous manner. In particular, a need may exist for a welding device and a welding method which, with a relatively small effort with regard to equipment and/or expenditure, enables an achievement of welds which firstly make possible a connection of two components with advantageous electrical properties, in particular, low electrical resistance values and secondly enable a reliable mechanical coupling of both components. In particular, a need may arise for a welding device and a welding method which are advantageously suitable for welding thin metal films together and/or to a metal sheet, and which may therefore be used advantageously, for example, in the context of a production of battery cells.

Such needs may be met with the subject matter of one of the independent claims. Advantageous embodiments of the invention are defined in the dependent claims and the description below.

According to a first aspect of the present invention, a welding device is disclosed which has an ultrasonic welding device and a laser welding device. The welding device is herein configured to weld at least two components together by ultrasonic welding in a first area with the aid of the ultrasonic welding device and, during the ultrasonic welding process, to weld the two components together by laser welding in a second area which is smaller than the first area and at least partially lies within an outer periphery of the first area and/or borders the outer periphery of the first area, with the aid of the laser welding device.

According to a second aspect of the present invention which may optionally also be configured as a special embodiment of the invention according to the first aspect above, a welding device is proposed which has an ultrasonic welding device and a laser welding device. The ultrasonic welding device has an ultrasonic sonotrode and an anvil. The ultrasonic sonotrode and the anvil are arranged opposite to and spaced from one another and enclose an operational volume between them in which at least two components to be welded are to be arranged during an ultrasonic welding. The laser welding device has a laser for emitting a laser beam. The ultrasonic sonotrode and/or the anvil have a through opening bordering on and/or within a first area. The ultrasonic sonotrode and the anvil are configured to contact the two components in the first area, during the ultrasonic welding process, from opposite sides at contact surfaces and to weld the two components together by ultrasonic welding. The laser welding device is configured to direct the laser beam through the through opening onto a second area on the two components in order to weld the two components together additionally by laser welding.

According to a third aspect of the present invention, a method for welding at least two components is disclosed wherein the two components are welded together in a first area by ultrasonic welding and during the ultrasonic welding process, the two components are welded together by laser welding in a second area which is smaller than the first area and is arranged within an outer periphery of the first area.

Without restricting the scope of the invention in any way, ideas and possible features for embodiments of the invention may be regarded as being based, inter alia, upon the concepts and discoveries described below. Possible features and advantages of embodiments of the invention are therein described mainly in relation to an application for a production of battery cells. Thereby, however, it should not be precluded that embodiments of the invention may also be used for other purposes.

In the production of battery cells, a plurality of thin metal films must regularly be connected together and/or to a metal sheet serving as a substrate. The metal films lead herein to electrodes within the battery cell and typically have a very thin thickness of between 5 μm and 30 μm. Usually, the metal films consist of aluminium and have a thin aluminium oxide layer on their surface. The metal sheet may be part of an electrical contact of the battery cell that is contactable from outside and/or may be connected to one such. Typically, the metal sheet is substantially thicker than the metal films and has a thickness of several 100 μm, for example, of between 300 μm and 2 mm. In order to achieve lower series resistances, the metal sheet often consists of copper or a copper-containing alloy. Conventionally, the metal films are often connected together and/or to the metal sheet by laser welding. Therein, a high power laser beam is directed onto the metal films and/or onto the metal sheet so that metal situated there may briefly melt and, on subsequent solidification, a firm interlocking connection is formed between the components. By means of the brief melting of the metal, high connection strengths may be achieved. Furthermore, a through contact in the region of the laser weld site is possible. However, during the laser welding, it must be ensured that the metal films are also spaced from one another by a very small gap since otherwise the risk exists that the laser beam does not weld the metal films together as desired, but rather passes through some of the metal films. It has also been observed that the metal melted during the laser welding is harder, after the subsequent solidification, than the surrounding metal. Thereby or due to a brittleness associated therewith, breaks, cracks or similar may occur in regions bordering the laser weld site and thus a failure of the electrical and/or mechanical connection may occur between the two components.

As an alternative to the use of laser welding technologies, the metal films and/or the metal sheet may be connected together by means of ultrasonic welding. By means of ultrasonic welding, connection zones of large area and very high quality with regard to electrical properties may be achieved, so that a large current transfer through the weld site is possible. However, the mechanical connection strengths to be achieved by ultrasonic welding are usually lower in comparison with laser welding.

It has already been acknowledged that advantages achievable, firstly, by means of laser welding and, secondly, by means of ultrasonic welding may be combined and/or disadvantages associated with the respective welding technology may be reduced in that a large area weld site created initially by ultrasonic welding may subsequently be reinforced at one or more smaller area points by means of laser welding.

It has been discovered for the present invention that the two welding technologies of laser welding and ultrasonic welding may be combined more advantageously with one another if they are carried out not sequentially one after the other, but rather substantially simultaneously and/or temporally overlapping.

In order to enable such simultaneous ultrasonic and laser welding, the ultrasonic welding device used in the welding device according to the invention may be configured to connect the two components to be welded within a first area, that is, within a first surface region on a boundary area between the two adjoining components, by means of ultrasonic welding. For this purpose, an ultrasonic sonotrode and an anvil of the ultrasonic welding device may be configured such that they at least lightly press the two components that are accommodated in the operational volume between the ultrasonic sonotrode and the anvil in the region of the first area against one another during the ultrasonic welding process and excite them into oscillations relative to one another. The oscillations may preferably be excited in a plane parallel to the boundary area between the mutually abutting components and/or parallel to a surface of the component on which the sonotrode abuts.

The ultrasonic sonotrode may be configured, with regard to its external dimensions, its oscillation-inducing components and other functional and/or function-related properties in the same or a similar manner as conventional ultrasonic sonotrodes. The anvil may also be configured, with regard it its external dimensions and other structural and/or functional properties, in the same or a similar manner as conventional anvils.

The ultrasonic welding device used in the welding device described here should, however, preferably differ from conventional ultrasonic welding devices at least in that a through opening is provided in the ultrasonic sonotrode and/or in the anvil. Expressed differently, the ultrasonic sonotrode and/or the anvil may be a non-continuous solid component, but rather, for example, may have a through hole in the middle.

The through opening may have a cross-sectional area that is significantly smaller than an area with which the sonotrode lies against the components that are to be welded. For example, the through opening may have a cross-sectional area of less than 10 mm², preferably less than 2 mm², but more than 0.1 mm². A cross-section of the through opening may be round or rectangular or may have any other geometry. In particular, the through opening may be cylindrical.

The through opening herein extends though the ultrasonic sonotrode and/or the anvil. The through opening forms a linear passage between a first surface of the ultrasonic sonotrode and/or the anvil and an oppositely arranged second surface of the ultrasonic sonotrode and/or the anvil.

The through opening extends in a direction transversely to a surface with which the ultrasonic sonotrode and/or the anvil borders on components to be welded that are accommodated in the operational volume. The through opening herein opens within an outer periphery of the first area to be welded by means of the ultrasonic welding device. The contact surface of one of the components to be welded that is contacted by the ultrasonic sonotrode and/or the anvil is therefore not a continuous area, but has a partial region bordering on the through opening, at which partial region the sonotrode and/or the anvil does not contact the surface of the relevant component. Differently expressed, the contact surface may be annular, i.e. it may cover a peripherally enclosed surface and therein may surround the partial region not contacted by the sonotrode. An external contour of the contact surface and/or a cross-section of the through opening may have any desired geometries, i.e. for example, round, angular, in particular, square or rectangular.

The laser welding device of the welding device described here may thus be configured to direct the laser beam emitted by its laser through the through opening described onto a second area on the two components to be welded. In particular, the laser welding may be performed with the aid of so-called laser spot welding. The second area lies within the partial area not directly contacted by the sonotrode and/or the anvil, i.e. within the cut-out described above in the contact surface contacted by the sonotrode. With the aid of the high-energy laser beam, the two components may thus be laser welded locally in the second area. In particular, this laser welding may take place in the second area while the ultrasonic welding device simultaneously carries out the ultrasonic welding in the larger first area surrounding the second area.

Dependent upon the boundary conditions prevailing for a particular usage configuration and/or the requirements placed on a weld of two or more components that is to be created, it may be advantageous to provide the through opening in the ultrasonic sonotrode and to direct the laser beam of the laser welding device through this through opening onto the surface of the components directed to the ultrasonic sonotrode. In other usage configurations, however, it may be advantageous to provide the through opening in the anvil and thus to direct the laser beam of the laser welding device through the anvil onto the surface of the components that faces away from the ultrasonic sonotrode. In yet other configurations, it may be advantageous to provide through openings both in the ultrasonic sonotrode as well as in the anvil and, with the aid of laser beams, to generate laser weld sites on both the opposing surfaces of the components.

In principle, a configuration is also conceivable in which the laser welding device does not direct the laser beam through a through opening through the ultrasonic sonotrode or the anvil, but rather the laser beam is directed from the side onto the components to be welded. The laser beam may therein be directed in the plane of the components to be welded and/or in a direction parallel to or slightly inclined to this plane.

Whereas in the first-mentioned configuration in which the laser beam is directed through the through opening into the ultrasonic sonotrode and/or the anvil, the second area is preferably arranged completely within the outer periphery of the first area, in the second-mentioned configuration in which the laser beam is directed from the side onto the components to be welded, the second area may also be arranged at least partially outside the first area but adjacent thereto. Expressed differently, in this second-mentioned configuration, the second area and the first area may also overlap at least partially and both areas may at least closely adjoin one another, i.e. a lateral spacing between the two areas should be minimal, in particular for example, less than 2 mm.

According to one embodiment of the invention, the welding device may also have a control device for controlling a synchronized operation of the ultrasonic welding device and the laser welding device.

Expressed differently, the welding device may have a control device with the aid of which the operation of its ultrasonic welding device and the operation of its laser welding device may suitably be temporally coordinated with one another. For this purpose, the control device must typically be able to communicate with the ultrasonic welding device as well as with the laser welding device. For example, the control device may control both a power supply to the ultrasonic welding device and also a power supply to the laser welding device.

According to a further specific embodiment of the invention, the control device may be configured to carry out the laser welding by controlling the laser welding device, while the ultrasonic welding is carried out by controlling the ultrasonic welding device.

In other words, the control device may control the ultrasonic welding device to excite the ultrasonic sonotrode into oscillations within a first time period and thereby to weld the two components in the first area by means of ultrasound. Furthermore, the control device may actuate the laser welding device within a second time period to weld the two components together locally in the second area by emitting the laser beam. The first time period and the second time period should be simultaneous or at least temporally overlapping so that the laser welding takes place while the ultrasonic welding is carried out. Typically, the second time period during which the laser welding takes place, is shorter or at most as long as the first time period during which the ultrasonic welding takes place. Thus, the ultrasonic welding may, for example, already be started before the laser welding is brought about and/or the ultrasonic welding may still be continued briefly after the ending of the laser welding. In principle, the first time period may begin before the second time period and the first time period may end before, simultaneously with or after the second time period. Alternatively, both time periods may begin simultaneously and the first time period may end before, simultaneously with or after the second time period. As a further alternative, the second time period may begin before the first time period and the first time period may end before, simultaneously with or after the second time period. Typical durations for the first and/or the second time period are in the range from a few 10 ms through to a few seconds, for example, between 0.05 s and 1 s, preferably between 0.1 s and 0.5 s.

In that, with the aid of the welding device described here, a welding of two components may be carried out simultaneously both by means of ultrasonic welding and also by means of laser welding in closely adjacent first and second areas, one or more of the subsequently described advantages may be achieved.

Inter alia, in the first area, a large area connection zone may be generated as is typical in ultrasonic welding. Within this connection zone, low electrical internal resistances may be achieved which may be at the high qualitative level of weld connections generated by ultrasonic welding and thus may have lower electrical resistances than occur in weld connections generated exclusively by laser welding.

Furthermore, at least in the second area, connection strengths may be attained as may typically be achieved during laser welding and which are typically greater than the connection strengths producible by means of ultrasonic welding.

An overall welding process may therein be achieved in a single operation. Furthermore, the whole welding process may be carried out with the aid of a single welding device.

It is also assumed that if laser welding and ultrasonic welding are performed simultaneously, advantageous boundary conditions may be created for the laser welding. In particular, it is assumed that a melt which is briefly created during laser welding by means of an energy input by the laser into the components to be welded may be homogenized due to the oscillations simultaneously generated during the ultrasonic welding. By means of the homogenization, for example, local temperature gradients within the melt may be reduced and/or other differences between locally prevailing physical properties within the melt may be reduced. This homogenization may advantageously affect the weld site generated by the laser welding after the subsequent solidification.

Furthermore, it has been observed that since the laser welding is carried out simultaneously with the ultrasonic welding, a laser power to be used for the laser welding may be enormously less in many usage cases than in usage cases in which components are connected together exclusively by laser welding. Simultaneous ultrasonic welding appears to provide for a particular energy input into the material at the laser weld site and/or adjacent thereto, which assists the laser welding.

Accordingly, the laser welding device may be configured, according to one embodiment of the laser welding device, to emit laser light with a power of less than 3 kW, preferably less than 1.5 kW.

Such relatively low laser power levels may also suffice, in particular, in conjunction with the simultaneous ultrasonic welding, to be able to weld together components with a substantial mass, i.e. for example, components in the form of metal sheets and not only thin films. Conventionally, for this purpose, lasers must normally be used which have a laser power of, for example, 4 kW or more. Through the use of lasers of lower power, both costs for the laser and costs for its energy consumption may be reduced.

The simultaneous or temporally overlappingly performed ultrasonic welding may preferably also be carried out with relatively low power levels, for example, with a power level of less than 12 kW or less than 8 kW, preferably less than 6 kW or even less than 4 kW. Thus, the two welding technologies, i.e. the ultrasonic welding and the laser welding, if they are carried out temporally overlapping, may be operated with significantly lower power levels than would be the case with a temporally separate execution.

According to one embodiment of the invention, the laser welding device may be configured to direct the laser beam onto the second area obliquely inclined to the contact surface.

Expressed differently, the laser of the laser welding device may be arranged and oriented such that the laser beam emitted therefrom meets the second area not perpendicularly, but at an oblique angle of, for example, between 1° and 89°, preferably between 30° and 85° and more preferably between 50° and 80° relative to the second area and/or to the contact surface which includes the second area.

Such an oblique incidence of the laser beam may be advantageous in that a weld site generated by laser welding does not necessarily extend perpendicularly to an external surface of the components to be welded, but oblique thereto into the components, for example, in the case of a plurality of thin films to be welded, through the components. Under mechanical loads which act in particular directions, a weld site that is obliquely oriented in this way may have a greater strength and/or a greater cohesion of the welded components than may be the case with a perpendicularly oriented weld site. In particular, a connecting area between the components to be welded in the case of an oblique laser beam incidence may be larger than with a perpendicular incidence.

According to one embodiment of the invention, the through opening which extends through the ultrasonic sonotrode and/or the anvil may be oriented obliquely to the contact surfaces.

It may also be possible, in principle, with a through opening extending perpendicularly to the contact surface, to have the laser beam pass through obliquely to the contact surface, provided the through opening has sufficiently large lateral dimensions, i.e. for example, it has a sufficiently large diameter. However, it may be advantageous to provide the through opening with the smallest possible lateral dimensions in order, for example, not to weaken the ultrasonic sonotrode excessively mechanically. In particular, it may be advantageous to provide the through opening with lateral dimensions that approximately correspond to the diameter of the laser beam to be fed through or are only slightly larger than this. In order to allow the laser beam to be able to impact obliquely relative to the contact surface, it may therefore be advantageous to allow the through opening also to pass obliquely through the sonotrode and/or the anvil. An angle at which the through opening is oriented relative to the contact surface with the components to be welded may therein approximately correspond to the angle described above at which the laser beam is to be directed onto the second area.

Alternatively, the through opening could be configured conically or biconically, so that the laser beam can pass obliquely through the through opening to the contact surface and nevertheless a mechanical stability of the ultrasonic sonotrode and/or the anvil having the through opening is not excessively reduced.

According to one embodiment of the invention, the ultrasonic sonotrode and/or the anvil may have a plurality of through openings within the first area. In this case, the laser welding device may be configured to direct laser beams through each of the through openings onto a plurality of second areas on the two components in order additionally to weld the two components together by laser welding.

In other words, the welding device may be configured, additionally to the welding of the components by ultrasonic welding, to connect the components not only at a single site by laser welding, but rather to generate a plurality of laser weld sites in that laser beams are directed to a plurality of second areas on the components.

Through the generation of a plurality of laser weld sites, a mechanical strength of the weld connection created may be increased. In particular, two, three, four or more laser weld sites may be created on a plurality of mutually adjacent and/or mutually spaced second areas.

For this purpose, a single laser beam emitted by a laser may be directed onto each of the second areas sequentially in order to create a laser weld site there. For example, the laser beam may be deflected successively with the aid of a suitable optical system. Alternatively, a single laser beam may be subdivided with the aid of a suitable optical system into a plurality of partial laser beams and then each of these partial laser beams may be directed onto one of the second areas in order to create a laser weld site there. As a further alternative, a plurality of lasers could be used which generate a plurality of laser beams and each of these laser beams could be directed onto one of the second areas.

According to one embodiment, the laser welding device may be configured to emit the laser beam for laser welding with laser light having a wavelength of less than 600 nm, preferably less than 500 nm. This means that in the welding method described, laser light with wavelengths in the aforementioned range may be used for laser welding.

This embodiment is based upon a realisation according to which particular components and/or components made of particular materials may particularly advantageously be laser welded with shorter wavelength laser light. Conventionally, for the laser welding, in particular, of metallic components, usually powerful lasers with laser light in the red or infrared wavelength region, i.e. with laser light having a wavelength of mostly greater than 700 nm, have been used. It has however been recognised that, for example, components made of non-ferrous metals, for example, copper or a copper alloy may advantageously be welded with shorter-wavelength laser light. In particular, green laser light, i.e. laser light with wavelengths of approximately 500-600 nm or even shorter wavelength blue light, that is, laser light with wavelengths of approximately 400-500 nm, may produce positive properties in the laser weld sites created thereby. In particular, the positive effect may occur that the short-wavelength laser light may be absorbed very efficiently in the material to be welded and thus a rapid melting of the material is enabled. The rapid melting may have the effect, inter alia, that non-ferrous metal may be melted without vaporisation, which may result in a greater stability of the weld pool thereby formed.

In general, for laser welding, lasers with different properties, with regard to an emitted laser light and/or a beam geometry, may be used. For example, dependent upon the prevailing boundary conditions, and the laser weld sites to be created, lasers may be used which continuously emit a laser beam, i.e. so-called cw (continuous wave) lasers. Such a cw laser may typically create laser weld sites within a few tens to a few hundreds of milliseconds, for example, between 0.1 s and 0.5 s. Alternatively, lasers which emit a pulsed laser beam may be used. A pulse duration may be selected to be application-specific and in a microsecond range, a nanosecond range, a picosecond range or even a femtosecond range.

The welding method described in addition to the welding device according to the third aspect of the invention may be carried out, in particular, with the aid of a welding device according to an embodiment of the first or second aspect of the invention. Accordingly, the features described for the welding device may similarly also be used for the welding method.

For example, in the welding method according to one embodiment, the components to be welded may be a plurality of metal films.

It is assumed that, in particular, when welding thin metal films such as, for example, aluminium films, as are needed for the production of battery cells, the described combination of ultrasonic welding and simultaneous laser welding enables very positive results.

In the pure laser welding previously used for this purpose, it has proved to be difficult to melt a plurality of the thin metal films simultaneously in a suitable manner locally. In particular, the risk existed that metal films, rather than being locally melted and thereby welded, were shot through by the laser beam. In particular, pure laser welding was sensitive with regard to existing air gaps between metal films that were to be welded. In addition, weld sites created by laser welding often have relatively poor electrical properties, in particular, relatively high electrical resistances.

On the other hand, although the sole use of ultrasonic welding for connecting metal films led to good electrical connections, the mechanical connections created thereby were often insufficient.

With the combination of ultrasonic welding and the simultaneously performed laser welding proposed here, the metal films may be pressed into contact with one another by the ultrasonic welding device and welded together in the first area and simultaneously, in the second area, the metal films abutting one another may be connected to one another in a low-risk manner by laser welding. By this means, an electrically highly conductive and nevertheless mechanically highly loadable integrally bonded connection may be created between the metal films.

According to an alternative embodiment, in the welding method, the components to be welded may be at least one metal film and at least one metal sheet.

This task of welding one or more thin metal films to at least one metal sheet may also arise, in particular, during the production of battery cells. The thin metal films may be connected to electrodes of, for example, a winding in the interior of the battery cell and must then be welded to a metal sheet which may also serve as a terminal contactable from outside. The metal sheet therein has a many times greater thickness than the metal films. In conventional laser welding, this may lead to problems in that the material of the metal sheet is more difficult or slower to melt than the material of the metal films. Dependent upon properties of the laser used for laser welding, as a result, damage to the metal films may occur and/or inadequate weld sites may form. It is assumed that in the aforementioned application case in particular, by means of a combination of ultrasonic welding and simultaneous laser welding, in an advantageous and reliable manner, weld sites may be created with both good electrical and also good mechanical properties.

According to one embodiment, in the welding method, at least one metal film and/or at least one metal sheet may consist predominantly of copper.

In particular, the metal film and/or the metal sheet may consist entirely of copper or a copper alloy. Such copper-containing components may have a very low series resistance, but were often at best difficult to process with conventional welding methods. With the welding method described here, for example, by using a short-wave laser together with the simultaneous ultrasonic welding, copper-containing components may also advantageously be welded to one another and/or to other metallic components.

It should be noted that possible features and advantages of embodiments of the invention are described here partially with regard to a welding device configured according to the invention and partially with regard to a welding method according to the invention. A person skilled in the art will recognise that the features described for individual embodiments may suitably be transferred in a similar way to other embodiments, adapted and/or exchanged in order to arrive at further embodiments of the invention and possibly to arrive at synergy effects.

### BRIEF DESCRIPTION OF THE DRAWINGS

Advantageous embodiments of the invention are described below in greater detail making reference to the attached drawings, although neither the drawings nor the description should be regarded in any way as limiting.

FIG. 1 shows a highly schematic view of a welding device according to an embodiment of the present invention.

FIG. 2 shows a schematic view of a sonotrode and an anvil of an ultrasonic welding device of a welding device according to an embodiment of the present invention.

FIG. 3 shows a sectional view of a sonotrode and an anvil of an ultrasonic welding device of a welding device according to an embodiment of the present invention.

FIG. 4 shows a plan view of film-like components that have been welded together with a welding method according to an embodiment of the present invention.

FIG. 5 shows a sectional view through a sonotrode and an anvil of an ultrasonic welding device of a welding device according to an alternative embodiment of the present invention.

FIG. 6 shows a plan view of film-like components that have been welded together with a welding method according to an alternative embodiment of the present invention.

The drawings are in general schematic and not to scale. Same reference signs in the different drawings relate to the same or similarly acting features.

### DESCRIPTION OF ADVANTAGEOUS EMBODIMENTS

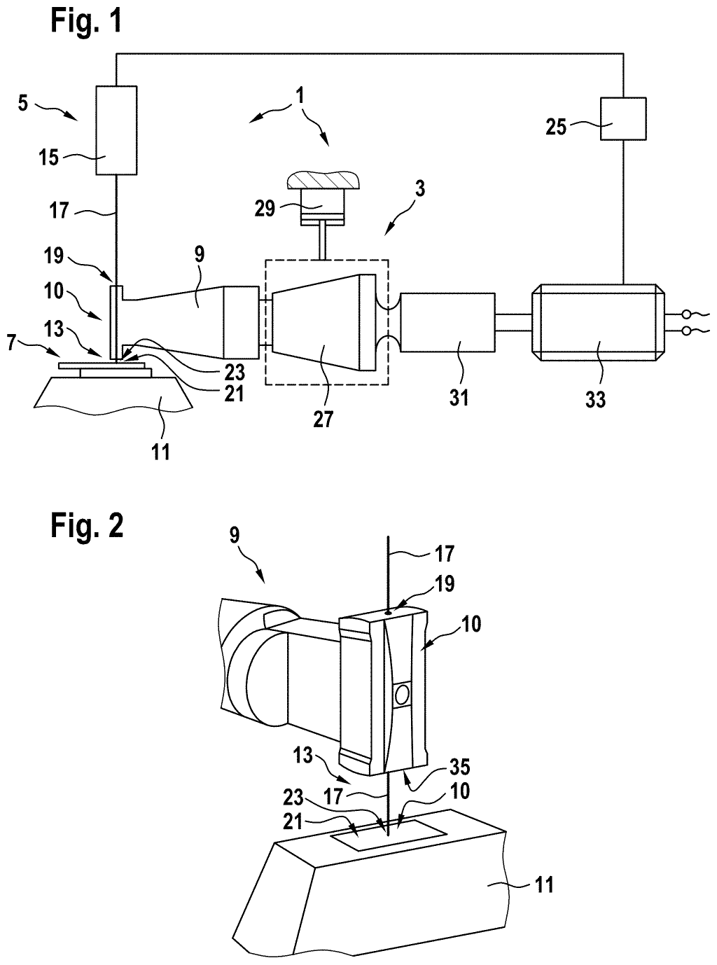

FIG. 1 shows a welding device 1 according to an embodiment of the invention. The welding device 1 comprises an ultrasonic welding device 3 and a laser welding device 5. An operation of the ultrasonic welding device 3 and an operation of the laser welding device 5 may therein each be controlled by a control device 25.

The welding device 1 is therein configured to accommodate at least two components 7 to be welded in an operational volume 13 and to weld them together simultaneously both in a first area 21 by ultrasonic welding and also in a second area 23 by laser welding.

As FIG. 2 shows additionally and in greater detail, the ultrasonic welding device 3 has an ultrasonic sonotrode 9 and an anvil 11 which are arranged at mutually opposing sides of the operational volume 13. Furthermore, the ultrasonic welding device 3 has an ultrasonic generator 33 in which ultrasonic oscillations may be generated at typical frequencies of between 20 kHz and 50 kHz. The ultrasonic oscillations may then be transferred by a converter 31 and a booster 27 as mechanical oscillations to the ultrasonic sonotrode 9. With the aid of an actuator 29, the booster 27 and the ultrasonic sonotrode 9 mechanically coupled thereto may be moved to the operational volume 13. In this way, a textured contact surface 35 on the ultrasonic sonotrode 9 may be pressed against a surface, facing said sonotrode, of one of the components 7 to be welded (component not shown in FIG. 2 for the sake of clarity). In this way, the components 7 to be welded may be clamped between the contact surface 35 of the ultrasonic sonotrode 9 and the anvil 11.

The ultrasonic welding device 3 described here differs from conventional ultrasonic welding devices, in particular, in that a through opening 19 is provided in its ultrasonic sonotrode 9 and/or its anvil 11, through which opening a laser beam 17 emitted by a laser 15 of the laser welding device 5 may be directed into the operational volume 13 and thus onto the components 7 accommodated there.

In the example shown, the through opening 19 is formed in the ultrasonic sonotrode 9. The through opening 19 therein extends transversely to the contact surface 35 through an entire sonotrode head 10. Accordingly, in the example described, the laser 15 arranged above the ultrasonic sonotrode 9 may direct its laser beam 17 through the through opening 19 onto the second area 23 on the upwardly facing surface of the upper components 7 to be welded.

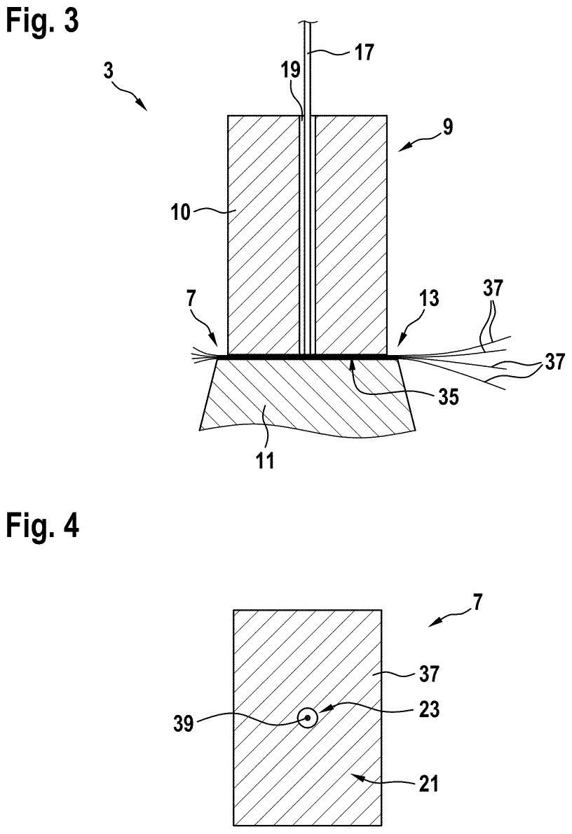

FIG. 3 shows a sectional view through the ultrasonic sonotrode 9 and the anvil 11 of an ultrasonic welding device 3. In the operational volume 13, components 7 to be welded in the form of a plurality of thin metal films 37 may be accommodated. For reasons of clarity, only four metal films 37 are shown, whereas in practice, there may be significantly more such metal films 37 to be welded together.

FIG. 4 shows a plan view of the components 7 to be welded.

During a welding process, the metal films 37 are pressed by the textured contact surface 35 of the ultrasonic sonotrode 9 against an opposite contact surface of the anvil 11 and are thus brought into abutment with one another. Therein, the ultrasonic sonotrode 9 conducts mechanical ultrasonic oscillations via the textured contact surface 35 into the stack of metal films 37, so that they are connected together by means of ultrasonic welding.

During the ultrasonic welding, the laser beam 17 is additionally directed through the through opening 19 in the ultrasonic sonotrode 9. In this way, a weld site 39 connecting the components 7 is created by laser welding simultaneously with the ultrasonic welding.

As a result of the through opening 19 provided in the ultrasonic sonotrode 9, the contact surface 35 of the ultrasonic sonotrode 9 is not over the whole area, but has a cut-out in its centre provided by the through opening 19. During the welding process, the ultrasonic sonotrode 9 may thus contact a large first area 21 on the components 7 with its ring-shaped contact surface 35 and may connect the components 7 there by means of ultrasonic welding. In the region of the cut-out, the laser beam 17 reaches a second area 23 and may create the approximately punctiform weld site 39 there by laser welding. The second area 23 is herein significantly smaller than the first area 21 and is situated within the first area 21, that is, it is surrounded by the first area 21 in an annular manner.

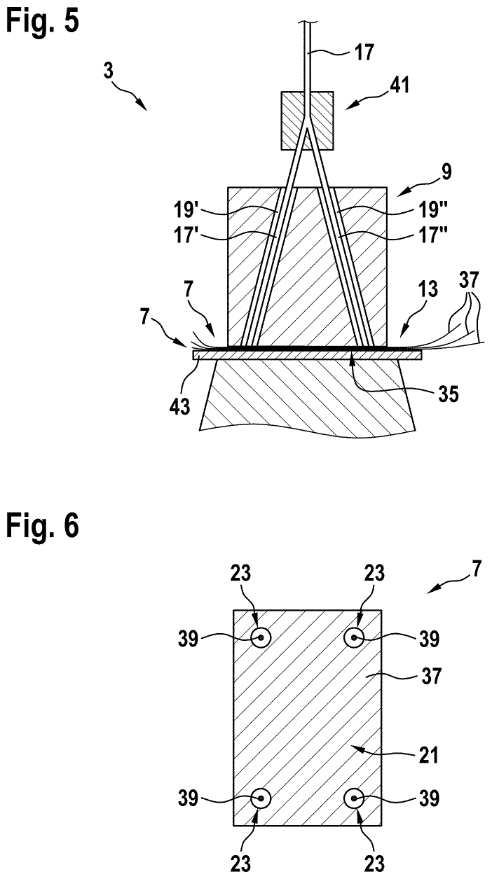

FIGS. 5 and 6 show a sectional view of an alternatively configured ultrasonic sonotrode 9 of an ultrasonic welding device 3 and a plan view of components 7 welded therewith.

In this case, the components 7 to be welded are a plurality of metal films 37 and a metal sheet 43 which is significantly thicker than the metal films 37. The metal films 37 and the metal sheet 43 may therein consist of different materials. In particular, the metal films 37 may consist, for example, of aluminium, whereas the metal sheet 43 may consist of copper or a copper alloy.

In this example, the ultrasonic sonotrode 9 has a plurality of through openings 19′, 19″. In the example shown, the laser beam 17 is subdivided with the aid of a beamsplitter 41 into a plurality of separate laser beams 17′, 17″. Each of the laser beams 17′, 17″ is directed through one of the through openings 19′, 19″ onto one of the plurality of second areas 23 in order to generate a plurality of weld sites 39 there by laser welding.

Finally, it should be pointed out that expressions such as “having”, “comprising”, etc. do not exclude any other elements or steps, and expressions such as “a” or “an” do not exclude a plurality. Furthermore, it should be pointed out that features or steps which have been described making reference to one of the above exemplary embodiments may also be used in combination with other features or steps of other exemplary embodiments described above. Reference characters in the claims are not to be interpreted as a restriction.

### REFERENCE SIGNS

1 Welding device
3 Ultrasonic welding device
5 Laser welding device
7 Components to be welded
9 Ultrasonic sonotrode
10 Sonotrode head
11 Anvil
13 Operational volume
15 Laser
17 Laser beam
19 Through opening
21 First area
23 Second area
25 Control device
27 Booster
29 Actuator
31 Converter
33 Ultrasonic generator
35 Textured contact surface
37 Metal films
39 Weld site
41 Beamsplitter
43 Metal sheet

1-15. (canceled)

16. A welding device, comprising:
an ultrasonic welding device, and
a laser welding device,
wherein the welding device is configured to weld at least two components together by ultrasonic welding in a first area with the aid of the ultrasonic welding device and, during the ultrasonic welding process, to weld the two components together by laser welding in a second area which is smaller than the first area and at least partially lies within an outer periphery of the first area and/or is arranged bordering the outer periphery of the first area, with the aid of the laser welding device.

17. A welding device, comprising:
an ultrasonic welding device, and
a laser welding device,
wherein the ultrasonic welding device has an ultrasonic sonotrode and an anvil, wherein the ultrasonic sonotrode and the anvil are arranged opposite to and spaced from one another and enclose an operational volume between them in which at least two components to be welded are to be arranged during an ultrasonic welding process,
wherein the laser welding device has a laser for emitting a laser beam,
wherein the ultrasonic sonotrode and/or the anvil have a through opening within a first area, wherein the ultrasonic sonotrode and the anvil are configured to contact the two components in the first area, during the ultrasonic welding process, from opposite sides at contact surfaces and to weld the two components together by ultrasonic welding, and
wherein the laser welding device is configured to direct the laser beam through the through opening onto a second area on the two components in order to weld the two components together additionally by laser welding.

18. The welding device according to claim 17, wherein the welding device also has a control device for controlling a synchronized operation of the ultrasonic welding device and the laser welding device.

19. The welding device according to claim 18, wherein the control device is configured to carry out the laser welding by controlling the laser welding device, while the ultrasonic welding is carried out by controlling the ultrasonic welding device.

20. The welding device according to claim 17, wherein the laser welding device is configured to direct the laser beam onto the second area obliquely inclined to the contact surface.

21. The welding device according to claim 17, wherein the through opening is oriented obliquely inclined to the contact surface.

22. The welding device according to claim 17, wherein the ultrasonic sonotrode and/or the anvil have a plurality of through openings (19′, 19″) within the first area, and wherein the laser welding device is configured to direct laser beams (17′, 17″) through each of the through openings (19′, 19″) onto a plurality of second areas on the two components in order to weld the two components together additionally by laser welding.

23. The welding device according to claim 16, wherein the laser welding device is configured to emit the laser beam for laser welding with laser light having a wavelength of less than 600 nm, preferably less than 500 nm.

24. The welding device according to claim 17, wherein the laser welding device is configured to emit the laser beam for laser welding with laser light having a wavelength of less than 600 nm, preferably less than 500 nm.

25. The welding device according to one of the preceding claim 16, wherein the laser welding device is configured, for laser welding, to emit laser light with a power of less than 3 kW.

26. The welding device according to one of the preceding claim 17, wherein the laser welding device is configured, for laser welding, to emit laser light with a power of less than 3 kW.

27. A method for welding at least two components, wherein the two components are welded together in a first area by ultrasonic welding and during the ultrasonic welding process, the two components are welded together by laser welding in a second area which is smaller than the first area and is arranged within an outer periphery of the first area.

28. The method according to claim 27, wherein the components to be welded are a plurality of metal films.

29. The method according to claim 27, wherein the components to be welded are at least one metal film and at least one metal sheet.

30. The method according to claim 27, wherein at least one metal film and/or at least one metal sheet consist predominantly of copper.

31. The method according to claim 29, wherein for laser welding, laser light having a wavelength of less than 600 nm, preferably less than 500 nm, is used.
